(19) United States
(12) Patent Application Publication
(10) Pub. No.: US 2020/0025060 A1
(43) Pub. Date: Jan. 23, 2020

(54) Fuel Injector and Nozzle Passages Therefor

(71) Applicant: GM Global Technology Operations LLC, Detroit, MI (US)

(72) Inventors: Scott E. Parrish, Farmington Hills, MI (US); Ronald O. Grover, JR., Northville, MI (US)

(21) Appl. No.: 16/040,127

(22) Filed: Jul. 19, 2018

(51) Int. Cl. F02B 23/10; F02M 51/06

(52) U.S. Cl. CPC F02B 23/104; F02M 63/0036; F02M 51/0657

(57) ABSTRACT

A fuel injector for an internal combustion engine. The fuel injector has a needle and a nozzle that inter-relate with each other in assembly. Relative movement between the needle and nozzle bring the fuel injector between a closed state of operation and an open state of operation amid use of the fuel injector. The nozzle has one or more passages therein through which fuel is discharged.

### INTRODUCTION

The present disclosure relates to fuel injectors equipped in automotive internal combustion engines and, more particularly, relates to nozzle passages for discharged fuel flow in fuel injectors.

Fuel delivery can impact the performance of internal combustion engines in automobiles. A direct fuel injector, for instance, is typically installed in a combustion chamber and is used to spray fuel directly into the combustion chamber. The fuel is atomized as it is forced through passages within a nozzle of the fuel injector. The nozzle passages of past fuel injectors are commonly cylindrical in shape and sometimes can have a counterbore configuration in which an individual nozzle passage has an initial cylindrical section of smaller diameter and a successive cylindrical section of larger diameter.

### SUMMARY

In an embodiment, a fuel injector includes a needle and a nozzle. The nozzle receives the needle in assembly. The nozzle has an advanced-manufactured portion. The nozzle also has one or more passages for discharged fuel flow amid use of the fuel injector. The passage(s) is defined in the advanced-manufactured portion.

In an embodiment, the passage(s) has a passage wall. The passage wall is defined in the advanced-manufactured portion.

In an embodiment, the passage(s) has an inlet end and an outlet end. The inlet end and the outlet end are defined in the advanced-manufactured portion.

In an embodiment, the passage(s) has a passage wall. The passage wall has a non-linear longitudinal extent. The passage(s) is defined in part or more by the non-linear longitudinal extent of the passage wall.

In an embodiment, the non-linear longitudinal extent of the passage wall constitutes a majority longitudinal extent of the passage wall.

In an embodiment, the passage(s) has a transverse cross-sectional profile. The transverse cross-sectional profile continuously varies in shape for a longitudinal extent of the passage(s) that constitutes a majority longitudinal extent of the passage(s).

In an embodiment, the transverse cross-sectional profile of the passage(s) continuously varies in shape for a full longitudinal extent of the passage(s).

In an embodiment, the passage(s) has an inlet end and has an outlet end. The passage(s) is defined by a passage wall between the inlet end and the outlet end. The passage(s) has a transverse cross-sectional profile with a twisting longitudinal extent from the inlet end and to the outlet end.

In an embodiment, the transverse cross-sectional profile with the twisting longitudinal extent has a generally tri-lobed shape.

In an embodiment, the transverse cross-sectional profile with the twisting longitudinal extent has a generally circular shape. The circular shape has one or more recessed shapes residing at a circumference of the generally circular shape.

In an embodiment, the passage(s) has an inlet end and has an outlet end. The passage(s) is defined by a passage wall between the inlet end and the outlet end. The passage(s) has a transverse cross-sectional profile with a converging longitudinal extent over a first section of a full longitudinal extent of the passage(s). The transverse cross-sectional profile also has a diverging longitudinal extent over a second section of the full longitudinal extent of the passage(s).

In an embodiment, the converging longitudinal extent is situated upstream of the diverging longitudinal extent. Upstream refers to the direction of discharged fuel flow through the passage(s).

In an embodiment, the converging longitudinal extent is situated downstream of the diverging longitudinal extent. Downstream refers to the direction of discharged fuel flow through the passage(s).

In an embodiment, the passage(s) has an inlet orifice edge. The inlet orifice edge is defined in the advanced-manufactured portion to have a pre-defined geometry.

In an embodiment, the passage(s) has a passage wall. The passage wall is defined in the advanced-manufactured portion. The passage wall defines the passage(s). The passage wall has an unsmooth surface that induces turbulence in discharged fuel flow thereover.

In an embodiment, the passage(s) has a transverse cross-sectional profile that exhibits asymmetry. The asymmetry is exhibited about a longitudinal axis of the passage(s).

In an embodiment, the passage(s) has an inlet end and has an outlet end. The inlet end has a transverse cross-sectional profile of a first shape. The outlet end has a transverse cross-sectional profile of a second shape. The first shape and the second shape differ from each other.

In an embodiment, the transverse cross-sectional profile of the first shape at the inlet end transitions to the transverse cross-sectional profile of the second shape at the outlet end. The transition occurs over a longitudinal extent of the passage(s) between the inlet and outlet ends.

In an embodiment, a fuel injector includes a needle and a nozzle. The nozzle receives the needle in assembly. The nozzle has one or more passages. The passage(s) is defined by a passage wall. The passage wall has a non-linear longitudinal extent. The non-linear longitudinal extent constitutes a majority, or more than a majority, longitudinal extent of a full longitudinal extent of the passage wall. The full longitudinal extent of the passage wall is defined between an inlet end of the passage(s) and an outlet end of the passage(s).

### BRIEF DESCRIPTION OF THE DRAWINGS

One or more aspects of the disclosure will hereinafter be described in conjunction with the appended drawings, wherein like designations denote like elements, and wherein:

FIG. 1 is a depiction of an example combustion chamber of an internal combustion engine with a direct fuel injector;

FIG. 2 is a schematic of the direct fuel injector that can be used with the internal combustion engine of FIG. 1;

FIG. 3 is an enlarged view of the direct fuel injector of FIG. 2;

FIG. 4 depicts a sectioned view of a needle and a nozzle of a previously-known direct fuel injector;

FIG. 5 is an enlarged sectional view of an embodiment of a nozzle passage;

FIG. 6 is a schematic view of the nozzle passage of FIG. 5;

FIG. 7 is a transverse profile of the nozzle passage of FIG. 5, taken about the arrows 7-7 in FIG. 5;

FIG. 8 is an enlarged sectional view of another embodiment of a nozzle passage;

FIG. 9 is a transverse profile of the nozzle passage of FIG. 8, taken about the arrows 9-9 in FIG. 8;

FIG. 10 is a schematic view of a further embodiment of a nozzle passage;

FIG. 11 is a schematic view of yet another embodiment of a nozzle passage;

FIG. 12 is a schematic view of another embodiment of a nozzle passage;

FIG. 13 is a schematic view of a further embodiment of a nozzle passage;

FIG. 14 is a schematic view of yet another embodiment of a nozzle passage;

FIG. 15 is an enlarged sectional view of another embodiment of a nozzle passage;

FIG. 16 presents a simulated fuel plume produced by a cylinder nozzle passage of uniform diameter;

FIG. 17 presents a simulated fuel plume produced by the nozzle passage of the embodiment of FIG. 8;

FIG. 18 presents a simulated fuel plume produced by the nozzle passage of the embodiment of FIG. 5; and

FIG. 19 is a graph comparing the velocities of the simulated fuel plumes of FIGS. 16, 17, and 18, with velocity magnitude in meters per second (m/s) plotted on a Y-axis, and with distance in micrometers (microns) plotted on an X-axis.

### DETAILED DESCRIPTION

With reference to the drawings, various embodiments of a nozzle passage of a fuel injector are set forth that provide enhanced control of fuel spray characteristics, and that ultimately can provide a cleaner and more efficient and more effective accompanying internal combustion engine. An advanced-manufactured portion is introduced into the design and construction of at least some embodiments of fuel injector nozzles in order to provide the nozzle passage embodiments and bring about these enhancements. The precise configuration of nozzle passages has been shown to strongly influence fuel spray control characteristics such as fuel spray atomization, air-fuel mixing, and fuel spray penetration, among other characteristics. The nozzle passage embodiments presented by the figures advance one or more of these characteristics compared to what has been previously known, as described more below. While described in the context of an automotive application in this description, the nozzle passage embodiments and their accompanying fuel injectors could be employed in non-automotive applications as well.

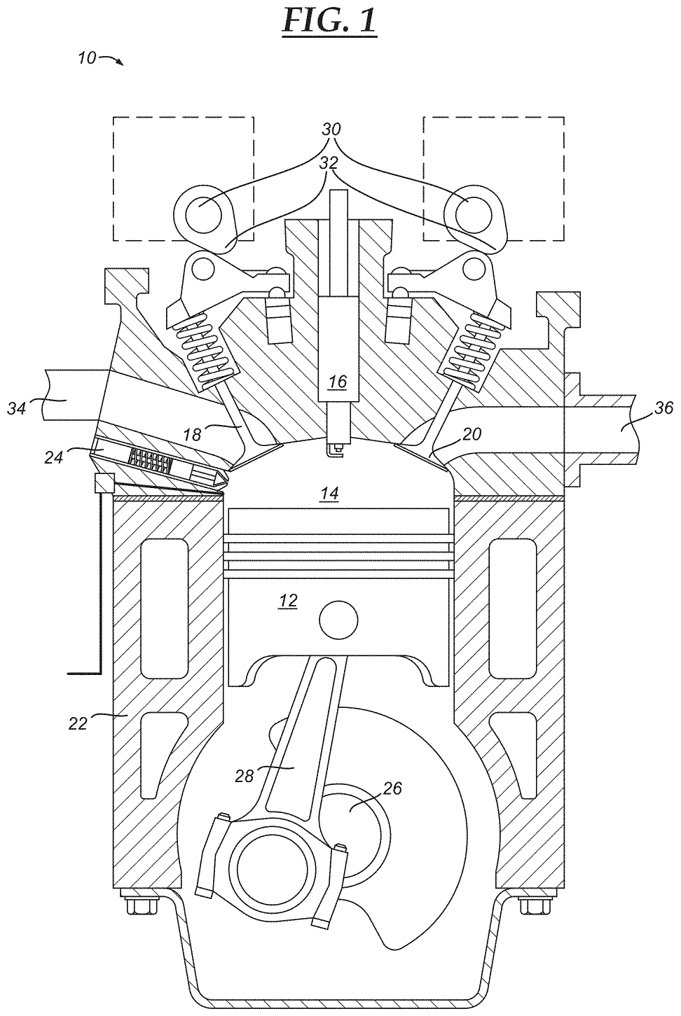

Referring now to FIG. 1, a section of an example internal combustion engine (ICE) 10 for an automobile is shown for explanatory purposes. In general, the ICE 10 includes a piston 12, a combustion chamber 14, a spark plug 16, an intake valve 18, an exhaust valve 20, a cylinder block 22, and a direct fuel injector 24. The piston 12 drives a crankshaft 26 by way of a connecting rod 28, and the intake and exhaust valves 18, 20 are actuated by camshafts 30 and their cams 32. The fuel injector 24 is used to inject fuel directly into the combustion chamber 14. At the appropriate time, a spark is initiated by the spark plug 16 to ignite an air-fuel mixture in the combustion chamber 14. An intake manifold 34 lets air into the combustion chamber 14, and an exhaust manifold 36 lets exhaust escape from the combustion chamber 14.

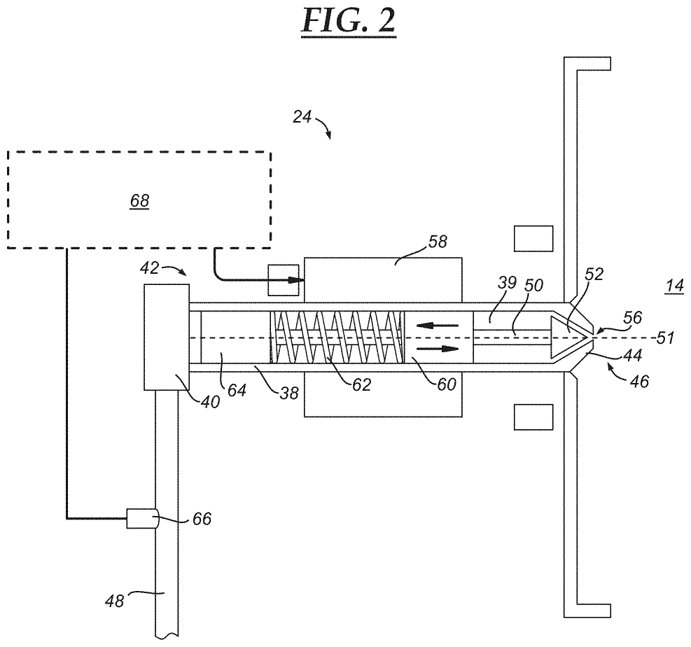

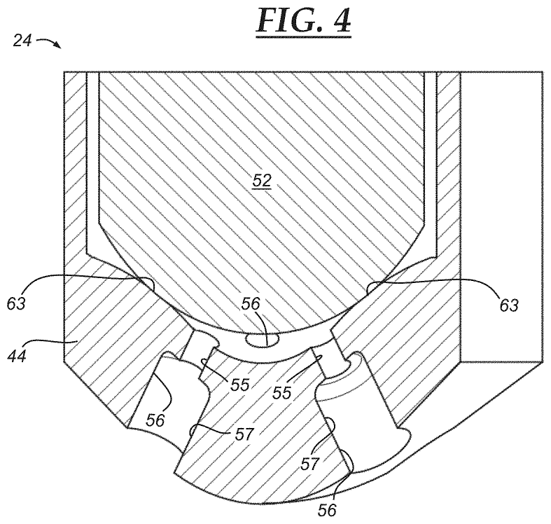

With reference to FIG. 2, an example of the fuel injector 24 is presented for explanatory purposes; skilled artisans will appreciate that other examples of fuel injectors could have different and/or other designs, constructions, and components than those set forth here. In the example, and in general, the fuel injector 24 includes a body 38 with a cavity 39 in which fuel can be communicated from a fuel inlet 40, to a nozzle 44, and ultimately out of passages 56. The fuel inlet 40 is located at a first end 42 of the body 38, and the nozzle 44 is located at a second end 46 of the body 38. The fuel inlet 40 is fed high-pressure fuel from a fuel line 48. A valve assembly is contained in the body 38, and includes a spring-activated plunger 50 and a needle 52, both of which are situated about a central longitudinal axis 51. The nozzle 44 has passages 56 through which fuel is discharged when the fuel injector 24 is in an open and activated state of operation of the fuel injector 24. Further, the fuel injector 24 includes an electromagnetic coil 58 that is configured to magnetically engage a guide portion 60. When the electromagnetic coil 58 is deactivated, a valve spring 62 urges the needle 52 toward and against the nozzle 44 to prevent fuel flow through the passages 56—this condition constitutes a closed and deactivated state of operation of the fuel injector 24. When in the closed state, the needle 52 makes abutment with the nozzle 44 to form a sealing seat 63 therebetween (FIG. 4). The sealing seat 63 is circumferentially continuous around the needle 52 and nozzle 44 abutment interface, and obstructs fuel flow thereat. When the electromagnetic coil 58 is activated, electromagnetic force acts on the guide portion 60 and overcomes a spring force exerted by the valve spring 62 and urges the fuel injector 24 to its open state, retracting the needle 52 away from the nozzle 44 and permitting fuel flow through the passages 56.

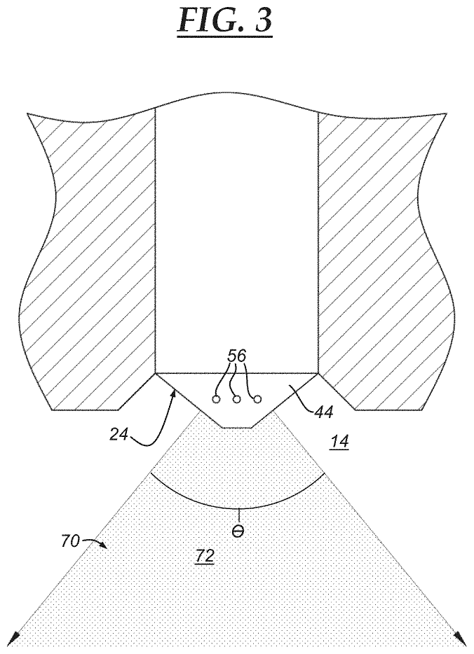

Furthermore, and still referring to FIG. 2, the fuel injector 24 may include a stopper 64 that halts movement of the needle 52 when the needle 52 retracts. A pressure sensor 66 may be included to monitor fuel pressure in the fuel line 48, and a control module 68 can receive signal outputs from the pressure sensor 66. The control module 68 can also be used to regulate activation and deactivation of the electromagnetic coil 58. Referring now to FIG. 3, the fuel injector 24 is depicted in general relation to the combustion chamber 14. A spray pattern 70 is produced when the fuel injector 24 sprays fuel 72 through the passages 56 of the nozzle 44. The spray pattern 70 makes a plume angle θ upon its discharge. And referring now to FIG. 4, a previously-known needle 52 and nozzle 44 of a fuel injector 24 is presented. The fuel injector 24 is shown in its closed state of operation. Nozzle passages 56 have a counterbore configuration with an initial cylindrical section 55 of a smaller diameter, and with a successive cylindrical section 57 of a larger diameter.

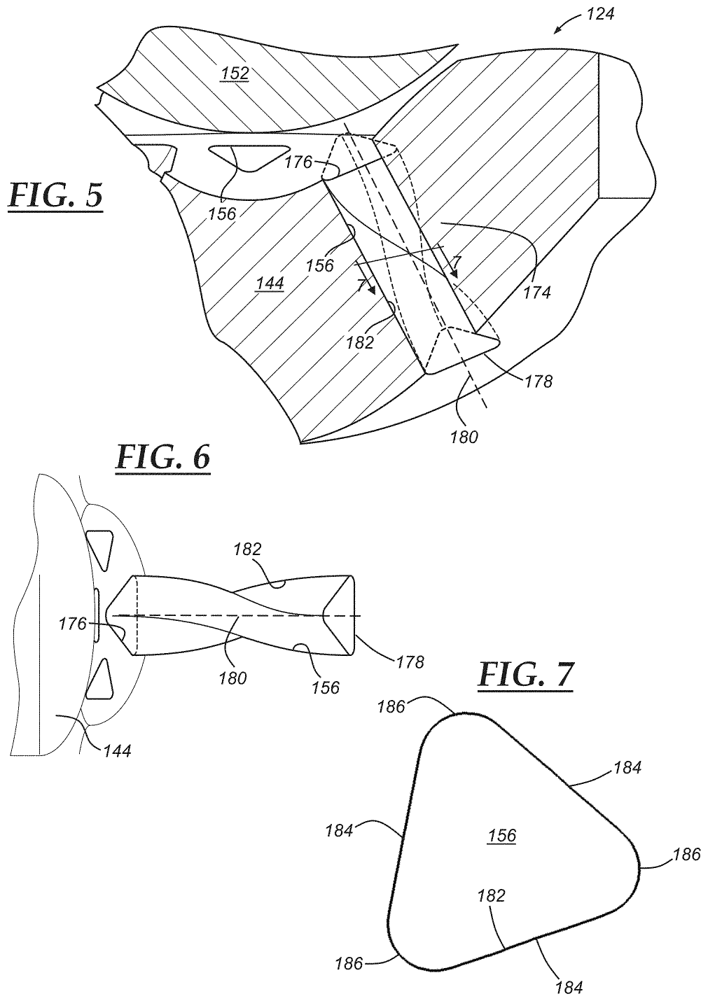

It has been determined that the precise configuration of nozzle passages—its shape, size, longitudinal extent, transverse profile, as well as other attributes—dictates fuel spray control characteristics such as, but not limited to, fuel spray atomization, air-fuel mixing, and fuel spray penetration. Exerting improved management over these fuel spray characteristics is sought for a cleaner and more efficient and more effective internal combustion engine. The nozzle passage embodiments of FIGS. 5-15 have hence been designed and constructed to exert certain degrees of control over these fuel spray characteristics. In at least some of the designs and constructions, an advanced-manufactured portion is furnished at the various nozzle passages. The advanced-manufactured portion can be fabricated by various advanced manufacturing technologies and techniques. One example involves additive manufacturing technologies and techniques; another example involves laser machining technologies and techniques; yet other examples include electro discharge machining (EDM) technologies and techniques, and LIGA (lithography, electroplating, and molding) technologies and techniques; still, other advanced manufacturing technologies and techniques are possible. In the additive manufacturing example, in an embodiment, additive-manufactured portions are composed layer-upon-layer via a three-dimensional (3D) printing process, or can be composed via a direct digital manufacturing process. The process can further involve plating technologies. Still, other types of additive manufacturing processes are possible in other embodiments. The additive manufacturing technologies and techniques can be carried out to manufacture only the particular additive-manufactured portion, or can be carried out to manufacture the larger component from which the additive-manufactured portion extends. The materials used in the additive manufacturing process can include certain metals and other suitable materials for fuel injector nozzles and/or needles.

FIGS. 5, 6, and 7 present a first embodiment of a needle 152 and a nozzle 144 of a fuel injector 124. The nozzle 144 has multiple passages 156 through which discharged fuel travels when the fuel injector 124 is in its open state of operation. With specific reference to FIG. 5, each passage 156 spans in full length from an inlet end 176 to an outlet end 178. Discharged fuel enters the passage 156 at the inlet end 176, passes through the length of the passage 156, and exits the passage 156 at the outlet end 178 to the accompanying combustion chamber. The passage 156 spans in length between the inlet and outlet ends 176, 178 about a longitudinal axis 180. The longitudinal axis 180 is centered in the passage 156. The passage 156 is defined by a passage wall 182 which extends between the inlet and outlet ends 176, 178. The passage wall 182 is, in a sense, an interior surface of the nozzle 144. In this embodiment, the passage 156, the inlet and outlet ends 176, 178, and the passage wall 182 are all defined in and reside in an advanced-manufactured portion 174 of the nozzle 144. It has been found that certain advanced manufacturing technologies and techniques are readily suited for fabricating nozzle passages like those of FIGS. 5-7 and unlike the previously-known nozzle passages, while more traditional manufacturing processes cannot always readily do so due to the preciseness now demanded.

In the embodiment of FIGS. 5-7, the design and construction of the passage 156 is thought to improve fuel spray penetration and to excite fuel flow momentum in a direction transverse to the longitudinal axis 180 upon exiting the outlet end 178; still, other enhancements can arise from this embodiment. Here, the passage 156 has a transverse cross-sectional profile with a twisting longitudinal extent. The transverse cross-sectional profile of the passage 156 is shown particularly in FIG. 7, and is a cross-section view taken orthogonal to the longitudinal axis 180. The twisting longitudinal extent refers to a shape of the transverse cross-sectional profile that continuously changes its angular position along the longitudinal axis 180—in other words, the shape rotates at different longitudinal positions. In the embodiment of FIGS. 5-7, the transverse cross-sectional profile has a generally tri-lobed shape of a triangle with three sides 184 and three rounded corners 186. The tri-lobed shape continuously twists in a single rotational direction about the longitudinal axis 180 as it spans directionally from the inlet end 176 to the outlet end 178 over the longitudinal axis 180. The degree of twisting, or angular displacement, of the tri-lobed shape from the inlet end 176 to the outlet end 178 can vary in different embodiments. In the example of the figures, its angular displacement is approximately one-hundred-and-twenty degrees. Further, the passage 156 and passage wall 182 have a non-linear and non-uniform longitudinal extent over their full longitudinal lengths from the inlet end 176 to the outlet end 178. In other embodiments, the shape of the transverse cross-sectional profile that exhibits this twisting longitudinal extent can vary and can have a non-circular shape such as a rectangular shape, a square shape, a polygonal shape, or some other shape.

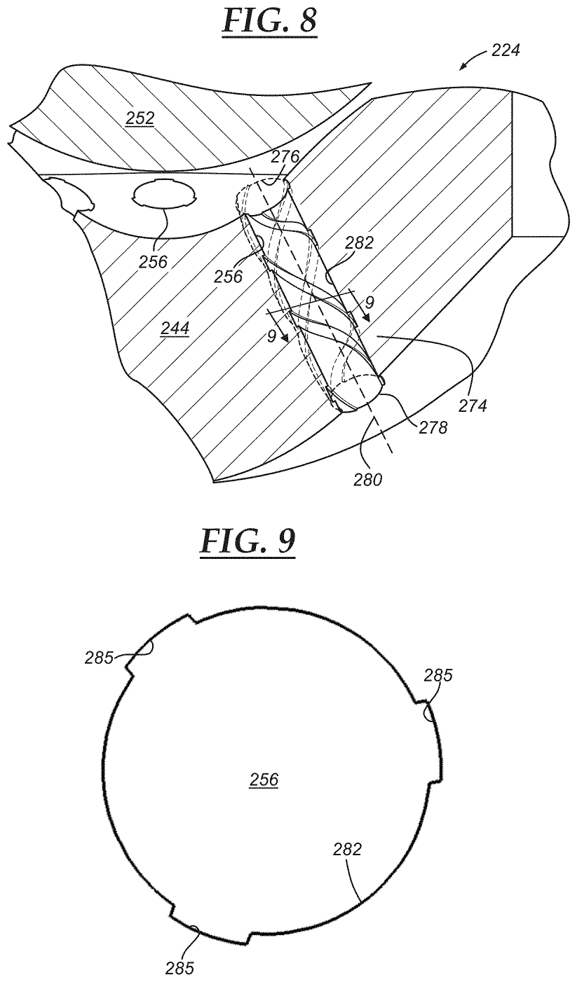

FIGS. 8 and 9 present a second embodiment of a needle 252 and a nozzle 244 of a fuel injector 224. The nozzle 244 has multiple passages 256 through which discharged fuel travels when the fuel injector 224 is in its open state of operation. Each passage 256 spans in full length from an inlet end 276 to an outlet end 278. As before, the passage 256 spans about a longitudinal axis 280 and is defined by a passage wall 282. The passage 256, the inlet and outlet ends 276, 278, and the passage wall 282 are all defined in and reside in an advanced-manufactured portion 274 of the nozzle 244. It has been found that certain advanced manufacturing technologies and techniques are readily suited for fabricating nozzle passages like those of FIGS. 8 and 9 and unlike the previously-known nozzle passages, while more traditional manufacturing processes cannot always readily do so due to the preciseness now demanded.

In the embodiment of FIGS. 8 and 9, the design and construction of the passage 256 is thought to improve fuel spray penetration and to excite fuel flow momentum in a direction transverse to the longitudinal axis 280 upon exiting the outlet end 278; still, other enhancements can arise from this embodiment. Here, the passage 256 has a transverse cross-sectional profile with a twisting longitudinal extent. The transverse cross-sectional profile of the passage 256 is shown particularly in FIG. 9. The twisting longitudinal extent refers to a shape of the transverse cross-sectional profile that continuously changes its angular position along the longitudinal axis 280—in other words, the shape rotates at different longitudinal positions. In the embodiment of FIGS. 8 and 9, the transverse cross-sectional profile has a generally circular shape with recesses 285 residing at a circumference of the circular shape; in other embodiments, there could be more or less of the recesses and they could have different shapes. The recesses 285 are set apart from one another by equal circumferential distances. The recesses 285 continuously twist in a single rotational direction about the longitudinal axis 280 as they span directionally from the inlet end 276 to the outlet end 278 over the longitudinal axis 280. The degree of twisting, or angular displacement, of the recesses 285 from the inlet end 276 to the outlet end 278 can vary in different embodiments. Further, the passage 256 and passage wall 282 have a non-linear and non-uniform longitudinal extent over their full longitudinal lengths from the inlet end 276 to the outlet end 278.

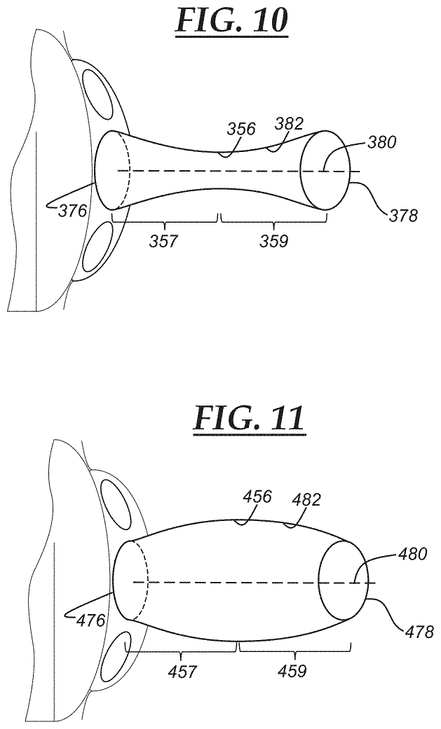

FIG. 10 presents a third embodiment of a needle and a nozzle of a fuel injector. For purposes of conciseness, the schematic view of the figure does not depict the accompanying needle and nozzle in the same manner as in previous figures, and rather primarily depicts a single passage 356. But it should be appreciated that the passage 356 can be implemented in a fuel injector nozzle as previously described in other embodiments, and hence such descriptions elsewhere are applicable here too. Discharged fuel travels through the passage 356 when the fuel injector is in is open state of operation. The passage 356 spans in full length from an inlet end 376 to an outlet end 378. The passage 356 spans about a longitudinal axis 380 and is defined by a passage wall 382. As before, the passage 356, the inlet and outlet ends 376, 378, and the passage wall 382 are all defined in and reside in an advanced-manufactured portion of the accompanying nozzle. It has been found that certain advanced manufacturing technologies and techniques are readily suited for fabricating nozzle passages like those of FIG. 10 and unlike the previously-known nozzle passages, while more traditional manufacturing processes cannot always readily do so due to the preciseness now demanded.

In the embodiment of FIG. 10, the design and construction of the passage 356 is thought to improve control over the plume angle of the resulting fuel spray pattern immediately upon exiting the outlet end 378 and to improve control over entrainment of the discharged fuel; still, other enhancements can arise from this embodiment. It is currently believed that the enhancements are brought about by accelerating and then decelerating discharged fuel flow through the passage 356. In this embodiment, the passage 356 has a transverse cross-sectional profile with an initially converging longitudinal extent, followed by a successive diverging longitudinal extent. The transverse cross-sectional profile of the passage 356 is circular in shape along its full longitudinal extent, as evidenced by the circular illustrations of the inlet end 376 and the outlet end 378 in FIG. 10. A first section 357, or initial section, of the passage 356 has a converging longitudinal extent in which the diameter of the circular transverse cross-sectional profile tapers from the inlet end 376 and toward a midpoint of the passage 356. The passage wall 382 is generally inclined radially inward over the first section 357. A second section 359, or successive section, of the passage 356 has a diverging longitudinal extent in which the diameter of the circular transverse cross-sectional profile grows from the passage's midpoint and toward the outlet end 378. The passage wall 382 is generally directed radially outward over the second section 359. The first section 357 is situated upstream of the second section 359 with respect to the direction of discharged fuel flow traveling through the passage 356, and the second section 359 is correspondingly situated downstream of the first section 357. Together, the first and second sections 357, 359 make up the full longitudinal extent of the passage 356. As discharged fuel travels through the passage 356, it accelerates through the first section 357 due to the experienced convergence, and then decelerates through the second section 359 due to the experienced divergence. The accelerating discharged fuel has a decreased pressure compared to the decelerating discharged fuel which has an increased pressure. Further, the passage 356 and passage wall 382 have a non-linear and non-uniform longitudinal extent over their full longitudinal lengths from the inlet end 376 to the outlet end 378.

FIG. 11 presents a fourth embodiment of a needle and a nozzle of a fuel injector. For purposes of conciseness, the schematic view of the figure does not depict the accompanying needle and nozzle in the same manner as in previous figures, and rather primarily depicts a single passage 456. But it should be appreciated that the passage 456 can be implemented in a fuel injector nozzle as previously described in other embodiments, and hence such descriptions elsewhere are applicable here too. Discharged fuel travels through the passage 456 when the fuel injector is in its open state of operation. The passage 456 spans in full length from an inlet end 476 to an outlet end 478. The passage 456 spans about a longitudinal axis 480 and is defined by a passage wall 482. As before, the passage 456, the inlet and outlet ends 476, 478, and the passage wall 482 are all defined in and reside in an advanced-manufactured portion of the accompanying nozzle. It has been found that certain advanced manufacturing technologies and techniques are readily suited for fabricating nozzle passages like those of FIG. 11 and unlike the previously-known nozzle passages, while more traditional manufacturing processes cannot always readily do so due to the preciseness now demanded.

In the embodiment of FIG. 11, the design and construction of the passage 456 is thought to improve control over pressure distribution of the discharged fuel as it travels through the full length of the passage 456, and to improve control over cavitation; still, other enhancements can arise from this embodiment such as encouraging spray atomization and greater plume angle control. It is currently believed that the enhancements are brought about by decelerating and then accelerating discharged fuel flow through the passage 456. In this embodiment, the passage 456 has a transverse cross-sectional profile with an initially diverging longitudinal extent, followed by a successive converging longitudinal extent. The transverse cross-sectional profile of the passage 456 is circular in shape along its full longitudinal extent, as evidenced by the circular illustrations of the inlet end 476 and the outlet end 478 in FIG. 11. A first section 457, or initial section, of the passage 456 has a diverging longitudinal extent in which the diameter of the circular transverse cross-sectional profile grows from the inlet end 476 and toward a midpoint of the passage 456. The passage wall 482 is generally directed radially outward over the first section 457. A second section 459, or successive section, of the passage 456 has a converging longitudinal extent in which the diameter of the circular transverse cross-sectional profile tapers from the passage's midpoint and toward the outlet end 478. The passage wall 482 is generally inclined radially inward over the second section 459. The first section 457 is situated upstream of the second section 459 with respect to the direction of discharged fuel flow traveling through the passage 456, and the second section 459 is correspondingly situated downstream of the first section 457. Together, the first and second sections 457, 459 make up the full longitudinal extent of the passage 456. As discharged fuel travels through the passage 456, it decelerates through the first section 457 due to the experienced divergence, and then accelerates through the second section 459 due to the experienced convergence. The decelerating discharged fuel has an increased pressure compared to the accelerating discharged fuel which has a decreased pressure. Further, the passage 456 and passage wall 482 have a non-linear and non-uniform longitudinal extent over their full longitudinal lengths from the inlet end 476 to the outlet end 478.

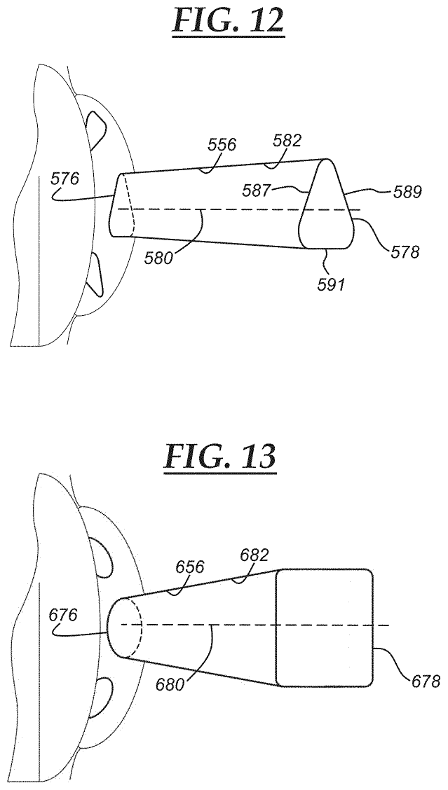

FIG. 12 presents a fifth embodiment of a needle and a nozzle of a fuel injector. For purposes of conciseness, the schematic view of the figure does not depict the accompanying needle and nozzle in the same manner as in previous figures, and rather primarily depicts a single passage 556. But it should be appreciated that the passage 556 can be implemented in a fuel injector nozzle as previously described in other embodiments, and hence such descriptions elsewhere are applicable here too. Discharged fuel travels through the passage 556 when the fuel injector is in its open state of operation. The passage 556 spans in full length from an inlet end 576 to an outlet end 578. The passage 556 spans about a longitudinal axis 580 and is defined by a passage wall 582. As before, the passage 556, the inlet and outlet ends 576, 578, and the passage wall 582 are all defined in and reside in an advanced-manufactured portion of the accompanying nozzle. It has been found that certain advanced manufacturing technologies and techniques are readily suited for fabricating nozzle passages like those of FIG. 12 and unlike the previously-known nozzle passages, while more traditional manufacturing processes cannot always readily do so due to the preciseness now demanded.

In the embodiment of FIG. 12, the design and construction of the passage 556 is thought to improve control over mass distribution of the discharged fuel as it travels through the full length of the passage 556 and, more particularly, asymmetrical mass distribution of the resulting fuel spray pattern such as an increased mass distribution at one region of the fuel spray pattern relative to another region with a decreased mass distribution; still, other enhancements can arise from this embodiment. Here, the passage 556 has a transverse cross-sectional profile that exhibits asymmetry about the longitudinal axis 580. The transverse cross-sectional profile can have various shapes that lack symmetry about the longitudinal axis 580, or that lack symmetry about a line/surface passing through the longitudinal axis 580 and passing through the transverse cross-sectional profile side-to-side. In the example of FIG. 12, the transverse cross-sectional profile has an asymmetrical shape with three somewhat bulbous and undulating and non-matching sides 587, 589, 591. The asymmetrical shape, whatever it may be, spans over the full longitudinal length of the passage 556 from the inlet end 576 to the outlet end 578. Further, the passage 556 and passage wall 582 have a non-linear and non-uniform longitudinal extent over their full longitudinal lengths from the inlet end 576 to the outlet end 578.

FIG. 13 presents a sixth embodiment of a needle and a nozzle of a fuel injector. For purposes of conciseness, the schematic view of the figure does not depict the accompanying needle and nozzle in the same manner as in previous figures, and rather primarily depicts a single passage 656. But it should be appreciated that the passage 656 can be implemented in a fuel injector nozzle as previously described in other embodiments, and hence such descriptions elsewhere are applicable here too. Discharged fuel travels through the passage 656 when the fuel injector is in its open state of operation. The passage 656 spans in full length from an inlet end 676 to an outlet end 678. The passage 656 spans about a longitudinal axis 680 and is defined by a passage wall 682. As before, the passage 656, the inlet and outlet ends 676, 678, and the passage wall 682 are all defined in and reside in an advanced-manufactured portion of the accompanying nozzle. It has been found that certain advanced manufacturing technologies and techniques are readily suited for fabricating nozzle passages like those of FIG. 13 and unlike the previously-known nozzle passages, while more traditional manufacturing processes cannot always readily do so due to the preciseness now demanded.

In the embodiment of FIG. 13, the design and construction of the passage 656 is thought to improve control over mass distribution of the discharged fuel as it travels through the full length of the passage 656, and to augment maintaining the structural integrity of the accompanying fuel injector nozzle; still, other enhancements can arise from this embodiment. The structural integrity can be maintained, in particular, by furnishing an inlet end section of the passage 656 with a reduced and/or differing size and/or shape compared to that of an outlet end section. The fuel injector nozzle would hence possess a structure of greater reinforcement and strength at the inlet end section than perhaps it would otherwise. In this embodiment, the inlet end 676 has a transverse cross-sectional profile of a first shape, while the outlet end 678 has a transverse cross-sectional profile of a second shape. The first shape and the second shape differ from each other, and can have various geometric forms. In the example of FIG. 13, the inlet end 676 has a circular shape and the outlet end 678 has a rectangular shape. Over the full longitudinal extent of the passage 656 from the inlet end 676 to the outlet end 678, the first shape steadily transitions in shape to the second shape. The transition can occur with other geometric forms of the first and second shapes of the respective inlet and outlet ends 676, 678. Further, the passage 656 and passage wall 682 have a non-linear and non-uniform longitudinal extent over their full longitudinal lengths from the inlet end 676 to the outlet end 678. And yet further, in this embodiment the passage 656 and passage wall 682 can continuously vary in shape and size over their full longitudinal lengths from the inlet end 676 to the outlet end 678.

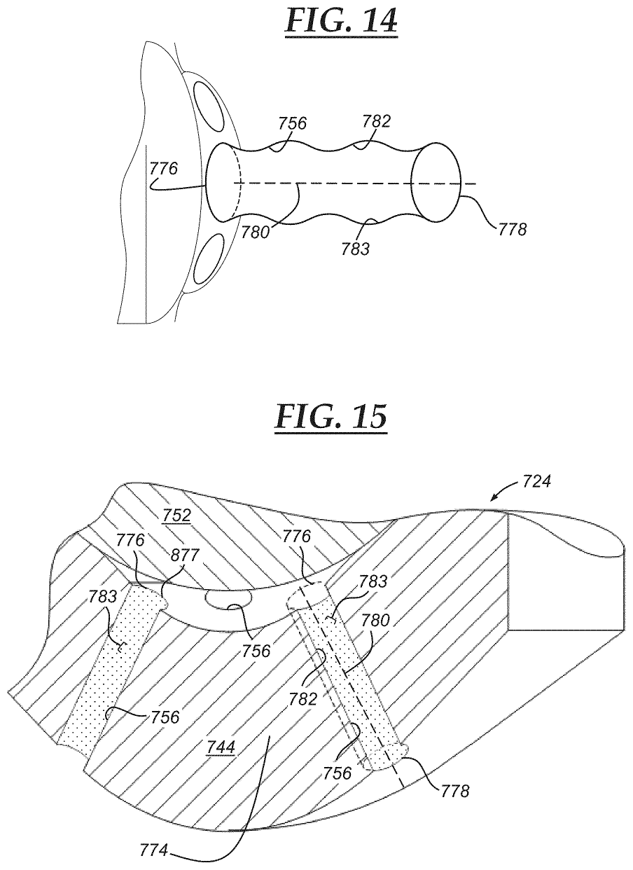

FIGS. 14 and 15 present a seventh embodiment of a needle 752 and a nozzle 744 of a fuel injector 724. The nozzle 744 has multiple passages 756 through which discharged fuel travels when the fuel injector 724 is in its open state of operation. Each passage 756 spans in full length from an inlet end 776 to an outlet end 778. As before, the passage 756 spans about a longitudinal axis 780 and is defined by a passage wall 782. The passage 756, the inlet and outlet ends 776, 778, and the passage wall 782 are all defined in and reside in an advanced-manufactured portion 774 of the nozzle 744. It has been found that certain advanced manufacturing technologies and techniques are readily suited for fabricating nozzle passages like those of FIGS. 14 and 15 and unlike the previously-known nozzle passages, while more traditional manufacturing processes cannot always readily do so due to the preciseness now demanded.

In the embodiment of FIGS. 14 and 15, the design and construction of the passage 756 is thought to encourage spray atomization of the discharged fuel as it travels through the full length of the passage 756; still, other enhancements can arise from this embodiment. It is currently believed that the enhancements are brought about by inducing turbulent flow dynamics within the effected discharged fuel. In this embodiment, the passage wall 782 has an unsmooth surface 783 exposed to the discharged fuel traveling thereover. The unsmooth surface 783 can take the form of a surface roughness, surface texturing, surface unevenness, coarse surface, surface dimples, surface irregularities, minute surface projections, or the like. The unsmooth surface 783 can constitute the full longitudinal length of the passage 756 from the inlet end 776 to the outlet end 778, or can reside on merely one or more sections of the passage 756 such as an initial section and/or a middle section and/or a successive section. As discharged fuel travels through the passage 756, turbulence is initiated or amplified in the flow of fuel via the unsmooth surface 783. Further, the passage 756 and passage wall 782 can have a non-linear and non-uniform longitudinal extent over their full longitudinal lengths from the inlet end 776 to the outlet end 778. And yet further, in this embodiment the passage 756 and passage wall 782 can continuously vary in shape and size—however minute such variations might be—over their full longitudinal lengths from the inlet end 776 to the outlet end 778.

In an eighth embodiment, an inlet orifice edge of any one of the various nozzle passage embodiments previously presented can be designed and constructed to have a pre-defined geometry such as a pre-defined radius and size and shape. It is thought that this nozzle passage attribute improves control over separation of the discharged fuel as it travels through the associated inlet end, and improves control over cavitation; still, other enhancements can arise from this embodiment. With particular reference to FIG. 15 for explanatory purposes, an inlet orifice edge 877 of the inlet end 776 is furnished with the pre-defined geometry such as the pre-defined radius and/or size and/or shape. For example, the inlet orifice edge 877 can be pre-defined and controlled to have a more rounded and less sharp geometry than previously possible. It has been found that certain advanced manufacturing technologies and techniques are readily suited for fabricating inlet orifice edges with the pre-defined geometry and unlike the previously-known nozzle passages, while more traditional manufacturing processes cannot always readily do so due to the preciseness now demanded. The more traditional manufacturing processes, while suitable in certain cases, have been shown to produce an inlet orifice edge that is oftentimes sharper by default rather than being actively controlled; for instance, past inlet orifice edges can possess sharp radii on the order of 1 micrometer (micron) and/or that are irregular, causing a steeper-than-desired reduction in fluid pressure thereat.

In yet further embodiments not specifically depicted by the figures, the nozzle passage configurations shown and described above could be combined and intermingled. For instance, the twisting longitudinal extent could have the unsmooth surface, the transitioning inlet and outlet end shapes could have converging and diverging extents, or the like.

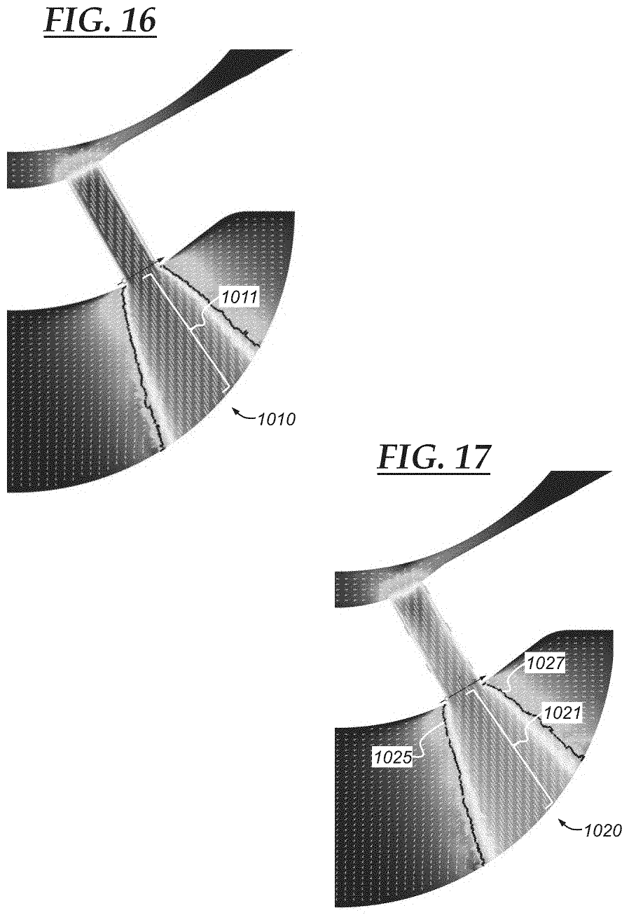

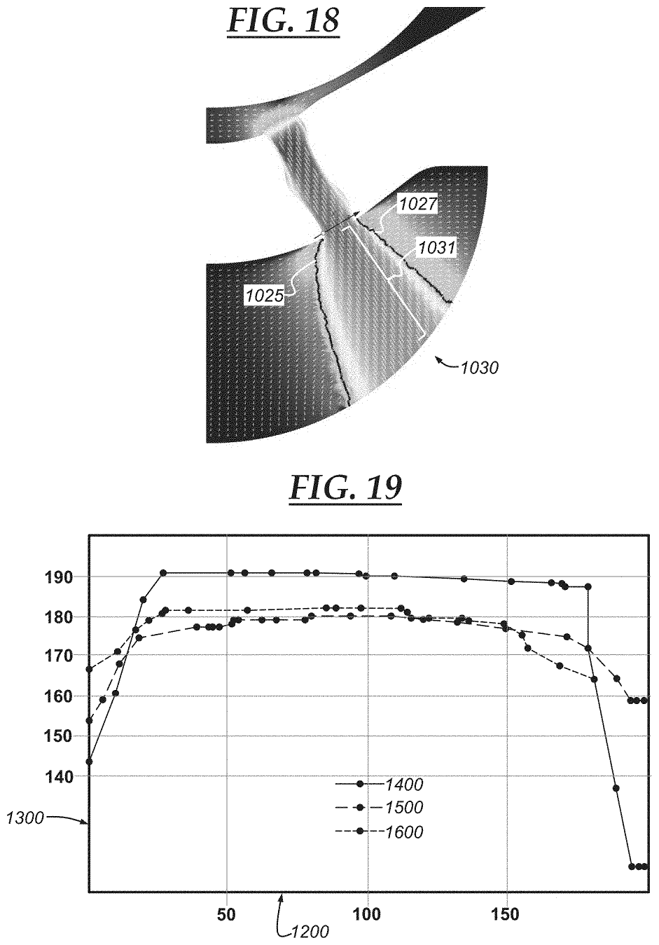

FIGS. 16-18 present simulated fuel plumes of different nozzle passage configurations, and FIG. 19 is a graph comparing the velocities of the simulated fuel plumes of FIGS. 16-18. A simulated fuel plume 1010 of FIG. 16 was produced by discharged fuel of a nozzle passage of cylindrical shape with a uniform and constant diameter of approximately 200 micrometers (microns) throughout a full longitudinal extent of approximately 650 microns. A simulated fuel plume 1020 of FIG. 17 was produced by discharged fuel of the nozzle passage 256 of FIGS. 8 and 9. And a simulated fuel plume 1030 of FIG. 18 was produced by discharged fuel of the nozzle passage 156 of FIGS. 5-7. Parameters set for preparing the simulated fuel plumes 1010, 1020,1030 in FIGS. 16-18 included: an injection pressure of 15 megapascals (MPa), an ambient pressure of 100 kilopascals (kPa), a fuel temperature of 25 degrees Celsius (° C.), and an ambient temperature of 20° C. In the simulated fuel plumes 1010,1020, 1030, the darker coloration indicates a higher velocity magnitude and the lighter coloration indicates a lower velocity magnitude. For instance, an area 1011 of the fuel plume 1010 has a darker color and hence a higher velocity magnitude than an area 1021 of the fuel plume 1020, and has a darker color and hence a higher velocity magnitude than an area 1031 of the fuel plume 1030. Furthermore, a transverse extent taken between sides 1025 and 1027 of the fuel plumes 1020 and 1030 is wider than that of the fuel plume 1010. This, it is currently believed, is a result of an improvement in excited fuel flow momentum in the direction transverse to the accompanying longitudinal axis upon exiting the associated outlet end. In the graph of FIG. 19, distance in microns is plotted on an X-axis 1200, and velocity magnitude in meters per second (m/s) is plotted on a Y-axis 1300. The distance on the X-axis 1200 is taken from the associated outlet end. A line 1400 denotes the simulated fuel plume 1010 of FIG. 16. A line 1500 denotes the simulated fuel plume 1020 of FIG. 17. And a line 1600 denotes the simulated fuel plume 1030 of FIG. 18. As demonstrated in the graph of FIG. 19, a peak velocity magnitude of the lines 1500 and 1600 is reduced by approximately 10 m/s compared to that of the line 1400. It has been determined that this reduction is desirable in certain embodiments as it generally results in reduced fuel spray penetration and hence less impinging fuel spray on combustion chamber surfaces. Also, reduced peak velocity has been shown to result in a wider fuel plume.

It is to be understood that the foregoing is a description of one or more aspects of the disclosure. The disclosure is not limited to the particular embodiment(s) disclosed herein, but rather is defined solely by the claims below. Furthermore, the statements contained in the foregoing description relate to particular embodiments and are not to be construed as limitations on the scope of the disclosure or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A fuel injector, comprising:
a needle; and
a nozzle receiving the needle, the nozzle having an advanced-manufactured portion and having at least one passage for discharged fuel flow, the at least one passage being defined in the advanced-manufactured portion.

2. The fuel injector of claim 1, wherein the at least one passage has a passage wall that is defined in the advanced-manufactured portion.

3. The fuel injector of claim 1, wherein the at least one passage has an inlet end and an outlet end, the inlet and outlet ends being defined in the advanced-manufactured portion.

4. The fuel injector of claim 1, wherein the at least one passage has a passage wall, the passage wall having a non-linear longitudinal extent, the at least one passage being defined at least in part by the non-linear longitudinal extent of the passage wall.

5. The fuel injector of claim 4, wherein the non-linear longitudinal extent of the passage wall constitutes a majority longitudinal extent of the passage wall.

6. The fuel injector of claim 1, wherein the at least one passage has a transverse cross-sectional profile that continuously varies in shape for a longitudinal extent of the at least one passage that constitutes a majority longitudinal extent of the at least one passage.

7. The fuel injector of claim 6, wherein the transverse cross-sectional profile of the at least one passage continuously varies in shape for a full longitudinal extent of the at least one passage.

8. The fuel injector of claim 1, wherein the at least one passage has an inlet end and an outlet end and is defined by a passage wall between the inlet and outlet ends, the at least one passage has a transverse cross-sectional profile with a twisting longitudinal extent from the inlet end to the outlet end.

9. The fuel injector of claim 8, wherein the transverse cross-sectional profile with the twisting longitudinal extent has a generally tri-lobed shape.

10. The fuel injector of claim 8, wherein the transverse cross-sectional profile with the twisting longitudinal extent has a generally circular shape with at least one recessed shape residing at a circumference of the generally circular shape.

11. The fuel injector of claim 1, wherein the at least one passage has an inlet end and an outlet end and is defined by a passage wall between the inlet and outlet ends, the at least one passage has a transverse cross-sectional profile with a converging longitudinal extent over a first section of a full longitudinal extent of the at least one passage, and with a diverging longitudinal extent over a second section of the full longitudinal extent of the at least one passage.

12. The fuel injector of claim 11, wherein the converging longitudinal extent is situated upstream the diverging longitudinal extent with respect to discharged fuel flow through the at least one passage.

13. The fuel injector of claim 11, wherein the converging longitudinal extent is situated downstream the diverging longitudinal extent with respect to discharged fuel flow through the at least one passage.

14. The fuel injector of claim 1, wherein the at least one passage has an inlet orifice edge, the inlet orifice edge defined in the advanced-manufactured portion to have a pre-defined geometry.

15. The fuel injector of claim 1, wherein the at least one passage has a passage wall that is defined in the advanced-manufactured portion and that defines the at least one passage, the passage wall having an unsmooth surface that induces turbulence in discharged fuel flow thereover.

16. The fuel injector of claim 1, wherein the at least one passage has a transverse cross-sectional profile that exhibits asymmetry about a longitudinal axis of the at least one passage.

17. The fuel injector of claim 1, wherein the at least one passage has an inlet end and an outlet end, the inlet end having a transverse cross-sectional profile of a first shape, the outlet end having a transverse cross-sectional profile of a second shape, the first and second shapes differing from each other.

18. The fuel injector of claim 17, wherein the transverse cross-sectional profile of the first shape at the inlet end transitions to the transverse cross-sectional profile of the second shape at the outlet end over a longitudinal extent between the inlet and outlet ends.

19. A fuel injector, comprising:
a needle; and
a nozzle receiving the needle, the nozzle having at least one passage for discharged fuel, the at least one passage being defined by a passage wall, the passage wall having a non-linear longitudinal extent that constitutes at least a majority longitudinal extent of a full longitudinal extent of the passage wall, the full longitudinal extent of the passage wall being defined between an inlet end of the at least one passage and an outlet end of the at least one passage.
